(19) United States
(12) Patent Application Publication
(10) Pub. No.: US 2007/0062227 A1
(43) Pub. Date: Mar. 22, 2007

(54) Securement system for the doors of vehicles, trailers and containers

(76) Inventor: Verne E. Thomsen, Ames, NE (US)

Correspondence Address: LAW OFFICES OF ADAM H. JACOBS;PATENT ATTORNEY, SUITE 726, 1904 FARNAM STREET, OMAHA, NE, 68102, US

(21) Appl. No.: 11/601,288

(22) Filed: Nov. 17, 2006

Related U.S. Application Data
(63) Continuation-in-part of application No. 11/029,089, filed on Jan. 4, 2005.

(51) Int. Cl. E05B 67/38

(52) U.S. Cl. 70/56

(57) ABSTRACT

An improved securement system for the doors of vehicles includes a first lock body having at least one bore hole and a second lock body having at least one bore hole, the first lock body mounted on a first door, the second lock body mounted on a second adjacent door. The first and second lock bodies are aligned such that upon the first and second doors being closed, the bore holes of each are generally concentrically aligned. A locking mechanism is mounted on the second lock body and a locking device including a pin securement block and a locking pin extends through the aligned bore holes with the pin securement block aligning with and engaging the locking mechanism to releasably secure the locking pin in the aligned bore holes thereby securing the first lock body to the second lock body to secure the doors in closed position.

### CROSS-REFERENCE TO RELATED PATENTS

This continuation-in-part patent application claims priority based on a Non-Provisional patent application Ser. No. 11/029,089 filed Jan. 4, 2005.

### BACKGROUND OF THE INVENTION

1. Technical Field

The present invention is directed to locking and securement devices for double door trailers and, more particularly, to a securement system for double doors which includes a first lock body having a mounting section and a lock engagement section having an upright pin-receiving hole formed extending therethrough, a second lock body having a second lock engagement section having a second bore hole and an upwardly extending mounting section for the locking mechanism, the first and second lock bodies being aligned such that upon the first and second doors being closed, the first and second lock engagement sections engage one another with the first and second bore holes being generally concentrically aligned, and a locking pin device having a locking pin and a upper pin securement block mounted on the locking pin such that the locking pin extends at least partially through the aligned first and second bore holes and the pin securement block is aligned with the locking mechanism to secure the locking pin in the bore holes thereby securing the first lock body to the second lock body and securing the first and second doors in closed position.

2. Description of the Prior Art

It has come to the attention of the inventor that large theft losses are being suffered by the railroad industry on the intermodal containers. Attempts of temporary locks have been marginally successful. A permanent hasp and security system is needed. The same hasp is designed to accommodate cargo vans and refrigerated vans for the trucking industry. This has been encouraged and reviewed by an executive of the Union Pacific Railroad. In addition, it is designed to be used as protection in our Homeland Security as the same containers are used in overseas shipments. In summary, it is to be used for theft protection on ships, trains, and trucks and for Homeland Security on ships, trains, and trucks.

### SUMMARY OF THE INVENTION

The present invention provides an improved securement system for the doors of vehicles, trailers or containers having two vertical side-by-side doors, the securement system including a first lock body including a mounting section and a first lock engagement section having a first bore hole extending through the first lock engagement section and a second lock body including a mounting section, a second lock engagement section having a second bore hole extending through the second lock engagement section and a locking mechanism mounting section extending upwards therefrom. The first lock body is adapted to be mounted on a first door of the two vertical side-by-side doors via the mounting section and the second lock body is adapted to be mounted on a second door of the two vertical side-by-side doors via the mounting section, the first and second lock bodies being aligned such that upon the first and second doors being closed, the first and second lock engagement sections engage one another with the first and second bore holes being generally concentrically aligned. A locking mechanism is mounted on the locking mechanism mounting section of the second lock body and finally a locking device is included which has a locking pin and an upper pin securement block mounted on the locking pin such that the locking pin extends at least partially through the aligned first and second bore holes and the pin securement block is aligned with the locking mechanism mounted on the second lock body such that the locking mechanism engages the pin securement block to releasably secure the locking pin in the aligned first and second bore holes thereby securing the first lock body to the second lock body and securing the first and second doors in closed position.

The improved securement system as thus described provides a substantial improvement over the various door locking and securement devices currently available. For example, because the device has no exposed bolts or mounting hardware, the standard tools of the trade used by thieves, including crowbars, screwdrivers, sledgehammers and other such lever-type and impact-type breaking and entering devices are rendered ineffective. Also, because the locking mechanism is easily accessible to the user of the invention yet is protected by the bulk of the second lock body, operation of the invention is greatly facilitated while destruction or disruption of the unit is still rendered quite difficult. Finally, because the present invention is designed to not require any specific installation or removal tools other than the key or other activation device for the locking mechanism, operation of the present invention is far easier than many devices currently being used for protection of trailer and container stored materials. The present invention thus provides a substantial improvement over those devices and methods found in the prior art.

### BRIEF DESCRIPTION OF THE DRAWINGS

FIG. 1 is a perspective view of the first embodiment of the securement device of the present invention.

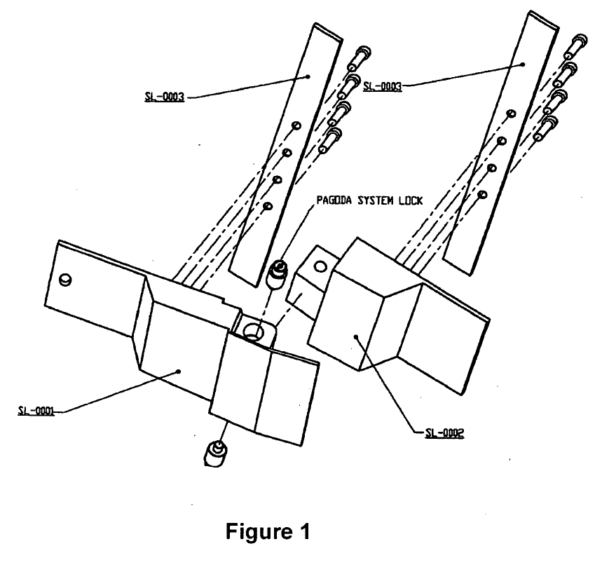

FIGS. 2 and 3 are, respectively, side elevational and perspective views of the first lock body of the first embodiment.

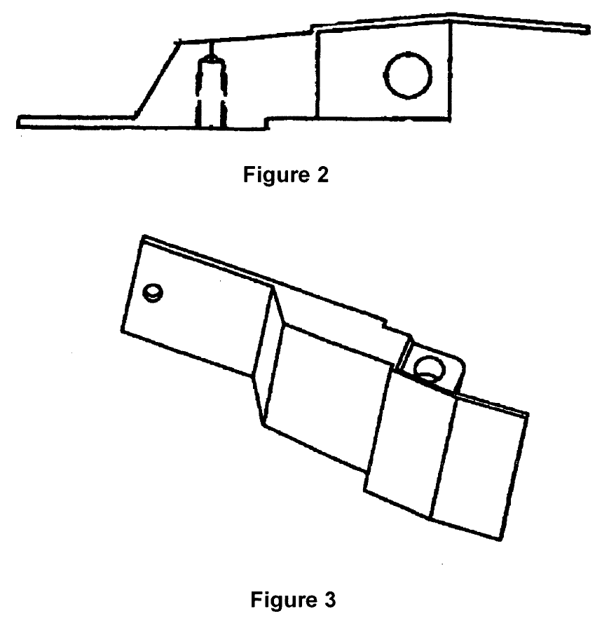

FIGS. 4 and 5 are, respectively, side elevational and perspective views of the second lock body of the first embodiment.

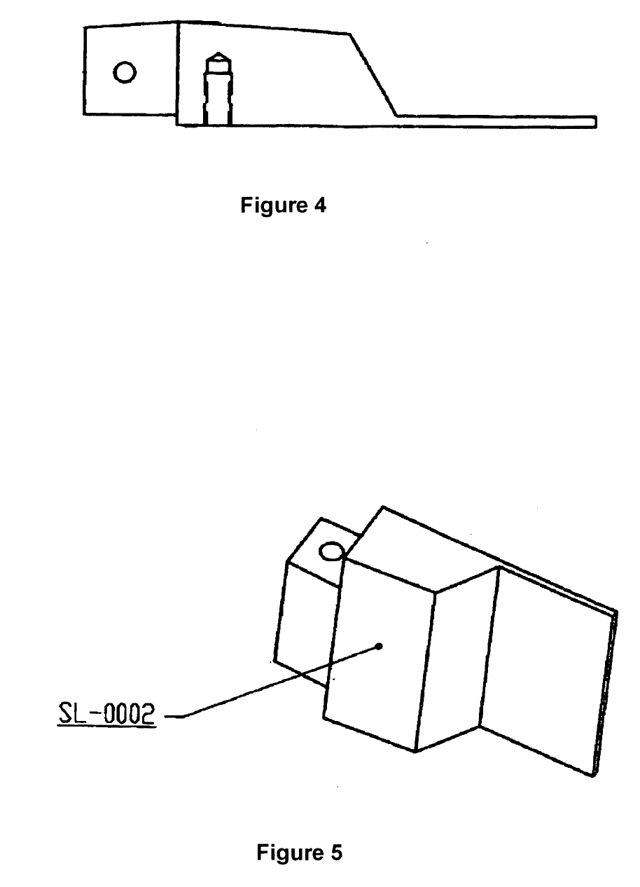

FIG. 6 is a side elevational view of the locking pin of the first embodiment.

FIG. 7 is a perspective view of the second embodiment of the securement device of the present invention.

FIG. 8 is a detailed side elevational view of the second embodiment showing the device mounted on a set of doors;

FIGS. 9 and 10 are detailed top plan views of the second embodiment showing the closing and locking of the device;

FIG. 11 is an exploded perspective view of the second embodiment.

FIG. 12 is a perspective view of the second embodiment mounted on a set of trailer doors.

FIG. 13 is a detailed perspective view of the second embodiment including an electronic lock mechanism.

### DESCRIPTION OF THE PREFERRED EMBODIMENT

The SLIKLOC Security System is a permanent locking system developed for the intermodal railroad containers, intermodal marine containers, and truck trailer cargo vans and refrigerated vans. The system is designed to be locked with a hydraulically removed locking pin, which is to be removed with a hydraulic removal tool. It can also be locked with the push type lock, which would be unlocked with a pagoda key, or the push type lock which would be unlocked with a barrel key. Each is available from ABA Lock Co. Each system can be used with the same hasp. The hydraulically removed pins are installed and removed without the push type locks installed. When the hydraulically removable pin is absent, the push type locks can be installed in either the top or bottom of the permanent hasp or both the top and bottom of the hasp. The locks are fixed in place with a 10/32″ allen screw.

The SLIKLOC assembly SL0001 and SL0002 are first poured out of Ductile Steel or similar hardened metal at approximately Rockwell C scale 42 to 48 and tensile strength of 50,000 to 70,000 PSI. The backing plate is mild steel with drilled holes to match the threaded SAE holes in the back of SL0001 and SL0002. After being poured at the foundry, they are machined according to the drawings. A protective, rust proof coating is applied. Examples of the materials used in the coating are powder coatings and zinc coatings. The SL0001 and SL0002 would then be installed on the left and right rear doors respectively of the marine or railroad intermodal containers or the semi-truck cargo or refrigerated vans by using a template or the like to correctly position the securement holes in the doors and properly secure the device on the doors.

With proper placement of the template at approximately in the middle of the vertical doors, the holes are drilled through the doors. The SL0001 and SL0002 are placed on the outside of the left and right side doors respectively. The backing plates are installed on the inside of the doors and fastened with cap screws (grade 5 or better) of proper length of two to five inches long depending on the thickness of the doors which extend into and are threadably secured within the SL0001 and SL0002. Shims can be used to acquire the proper tightness.

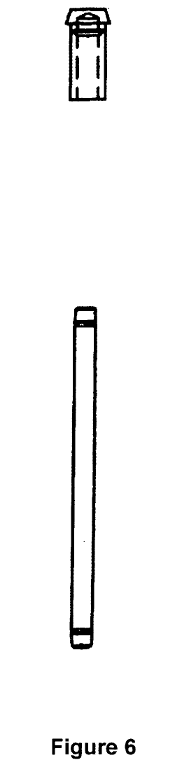

After installation, they can be locked with option 1, shown in FIG. 6, a machined pin shank (overall length is approximately 3 to 7 inches) and a seal pin cap secured with an internal snap ring. It is installed on the inside of the cap, which when put on, fits into the groove of the pin shank. (Note the pin shank and cap is only used once.)

To remove the pin, a hydraulic or pneumatic or mechanical jack is used to push a hardened pin through the cap pushing the pin shank down freeing the cap and pin shank from the internal snap ring. Optionally, a push button lock can be used. The lock is held in the top and bottom by a 10/32″ set screw. When the button is pushed down it locks and then can be opened with the proper keys (barrel keys or pagoda keys). The top and bottom locks can be keyed alike or differently depending on the level of security desired. The SLIKLOC Security System Permanent Locking Hasp has the highest level of anti-theft and anti-tampering design that virtually eliminates opening with a thief's tools of the trade—hacksaws, bolt cutters, large hammers, and pry bars. Most marine and railroad intermodal containers are unsecured or have limited security. Adding the SLIKLOC Security System to these modes of transportation would limit theft and decrease the chance of terrorists using these modes of transportation to damage our homeland.

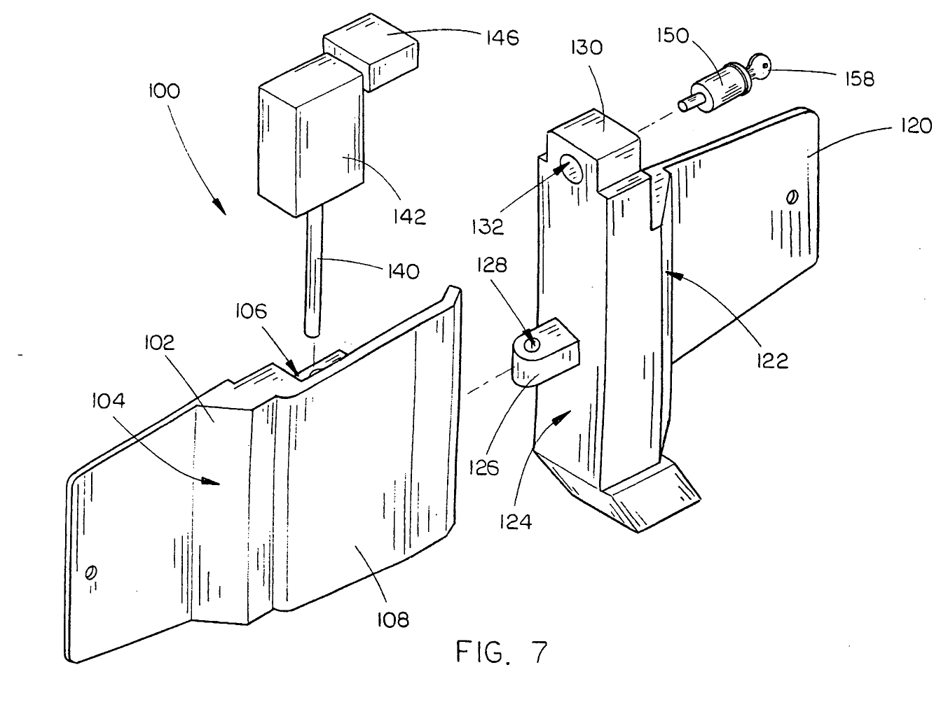

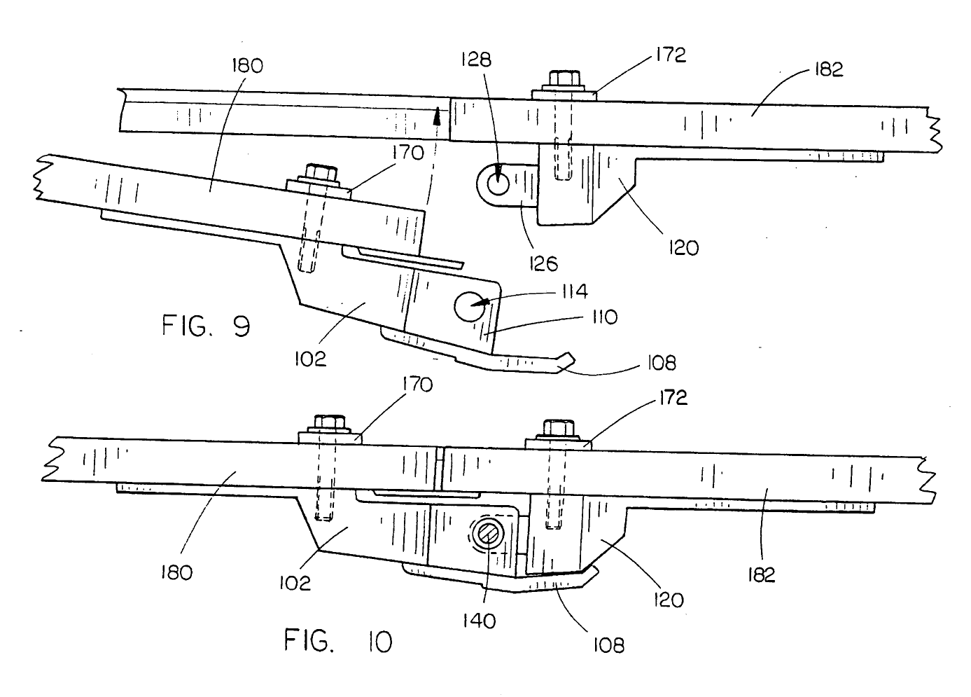

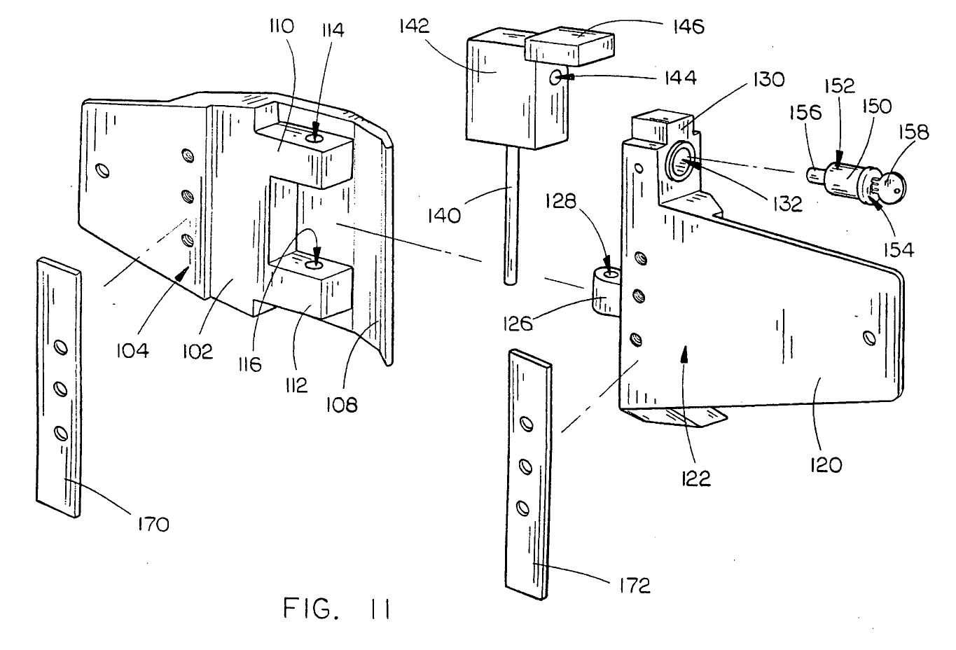

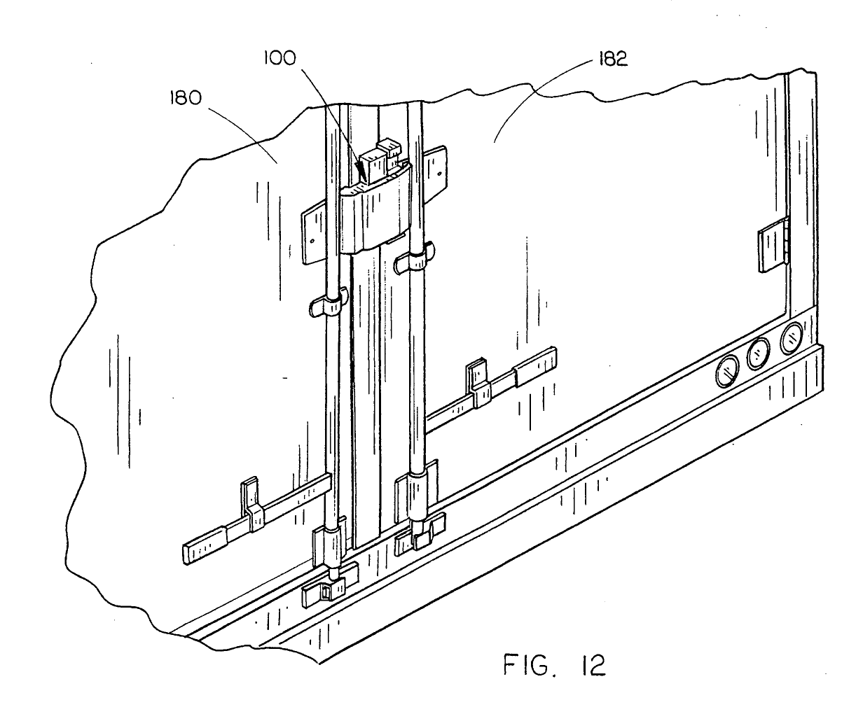

An alternative second embodiment of the securement system 100 is shown best in FIGS. 7-13 as including a similar arrangement of features as described in connection with the first embodiment of the securement system but would include several additional features which attempt to address and solve some problems encountered in use of the present invention. Specifically, the securement system 100 would include a first lock body 102 which includes a mounting section 104, a lock engagement section 106, and a generally rectangular cover plate 108 which extends over the first lock engagement section 106 and shields it from unauthorized manipulation or entry thereto. In the preferred embodiment, the first lock engagement section 106 would include upper and lower lock engagement fingers 110 and 112 each of which extend outwards from the mounting section 104 and each which include a generally vertical pin-receiving bore hole 114 and 116 which extends through each of the upper and lower locking engagement fingers 110 and 112, as shown best in FIGS. 12, 13, and 14. In the preferred embodiment, the upper and lower bore holes 114 and 116 in upper lock engagement finger 110 and lower lock engagement finger 112 are generally vertically aligned to permit the securement pin to extend simultaneously therethrough, although the precise placement and shape of the upper and lower bore holes 114 and 116 is not critical to the present invention so long as a single pin structure may extend through both bore holes 114 and 116 simultaneously.

The second lock body 120 is shown best in FIGS. 7-11 as including a mounting section 122 and a second locking engagement section 124 which preferably includes a central projecting finger 126 which includes a vertical bore hole 128 extending therethrough. The second lock body 120 would preferably be constructed in the same manner as first lock body 102 and of the same construction materials, and it is further preferred that the vertical bore hole 128 have a diameter similar to the diameter of upper and lower bore holes 114 and 116 on first lock body 102 such that a securement pin may extend through vertical bore hole 128 and upper and lower bore holes 114 and 116 as will be described later in this disclosure.

It is important to note that the securement system 100 of the second embodiment would preferably be mounted on the doors 180 and 182 of the tractor trailer or other such truck in generally the same manner as described in connection with the first embodiment, involving the use of a pair of backing plates 170 and 172 which would be secured to the backside of the doors 180 and 182 by a set of bolts which extend into and are threadably secured within the mounting sections 104 and 122 of the first and second lock bodies 102 and 120. The benefits with the securement system are that no bolts are exposed on the exterior of the securement system 100 which is critical in preventing unauthorized entry into the vehicle fitted with the securement system 100 of the present invention, and furthermore it is a feature which is not found in the vast majority of examples found in the prior art.

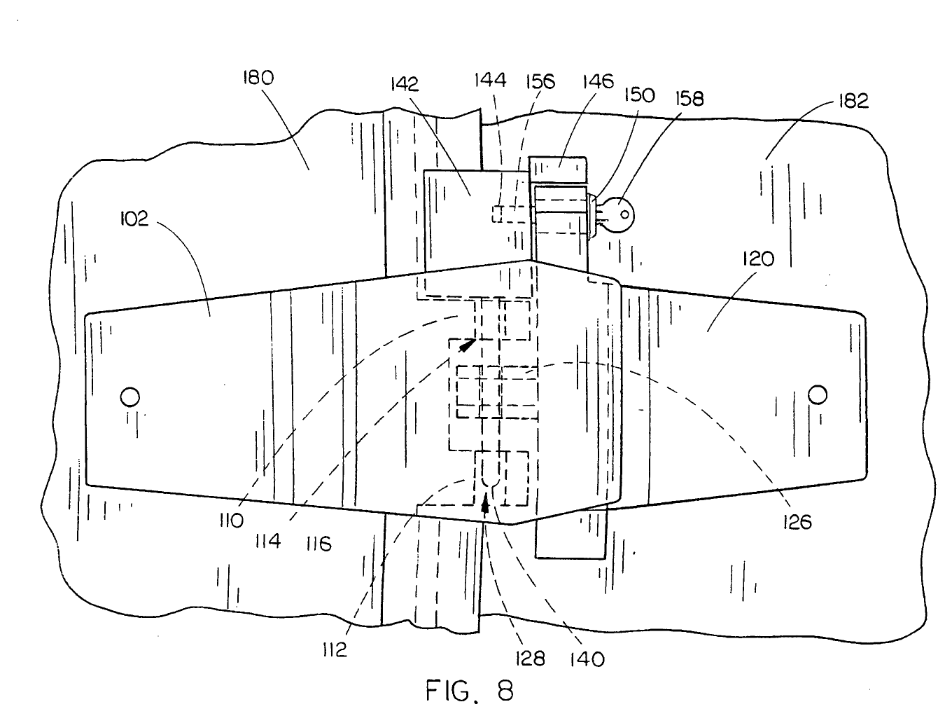

In any event, turning to the securement of first lock body 102 to second lock body 120, when the left and right doors 180 and 182 are closed, the first and second lock bodies 102 and 120 are aligned as shown in FIGS. 8-10 with the cover plate 108 of first lock body 102 extending over and covering the upper and lower lock engagement fingers 110 and 112 and projecting central finger 126 of first and second lock bodies 102 and 120. The upper and lower bore holes 114 and 116 of upper and lower lock engagement fingers 110 and 112 are aligned with the bore hole 128 of projecting central finger 126 to permit locking securement rod 140 to extend therethrough to secure the upper and lower lock engagement fingers 110 and 112 to projecting central finger 126 thereby securing the first and second lock bodies 102 and 120 to one another to prevent unauthorized opening of left and right doors 180 and 182.

Of course, the mere insertion of a locking securement pin 140 will not secure first and second lock bodies 102 and 120 in their closed position connected to one another without providing a mechanism for locking the locking securement pin 140 in its engaged position, as shown in FIG. 8-10. Therefore, mounted atop locking securement pin 140 is pin securement block 142 which, in the preferred embodiment, would be a generally rectangular block of hardened metal which includes a pin-receiving hole 144 formed on the side of pin securement block 142 and extending into the pin securement block 142 and an alignment plate 146 mounted atop pin securement block 142 and extending outwards therefrom to retain the pin securement block 142 and locking securement pin 140 in a pre-selected position in which the locking securement pin 140 extends through and connects the upper and lower bore holes 114 and 116 of upper and lower lock engagement fingers 110 and 112 with the bore hole 128 of projecting central finger 126 and further aligns the pin-receiving hole 144 of pin securement block 142 with the locking mechanism 150 which will be described shortly hereafter.

To lock the pin securement block 142 and hence locking securement pin 140 in their locking position, a locking mechanism 150 is mounted on the second lock body 120 in an upwardly extending locking mechanism mounting section 130 of second lock body 120 which, in the preferred embodiment, would include a locking mechanism receiving recess 132 into which the locking mechanism 150 would extend and be mounted therein. In the preferred embodiment, the locking mechanism 150 would be a Pagoda-type of lock which includes a lock body 152 having a key locking mechanism 154 and a forwardly-extending locking pin 156 which is extended or retracted by operation of the key locking mechanism 154. Pagoda locks are quite common and are used for everything from garage doors to vending machines, and the operational features of such locks are well known in the prior art, therefore they will not be discussed further in this disclosure.

Once the locking mechanism 150 is secured within locking mechanism mounting recess 132 of mounting section 130, the key locking mechanism 154 is accessible on the outside of the mounting section 130 so that the key 158 may be inserted into the key locking mechanism 154 for operation of the locking mechanism 150. The opposite end of the locking mechanism 150, specifically where locking pin 156 extends outward therefrom, is positioned on the opposite side of the mounting section 130 such that the locking pin 156, when projecting outwards, extends into the pin-receiving hole 144 of pin securement block 142 on locking securement pin 140 when the locking securement pin 140 and pin securement block 142 are placed in the position as shown best in FIG. 8. The alignment plate 146 correctly aligns the pin-receiving hole 144 with the locking pin 156 of locking mechanism 150 by preventing the pin securement block 142 from dropping below the locking mechanism 150, and therefore when the locking pin 156 extends outwards into the pin-receiving hole 144, the locking securement pin 140 and pin securement block 142 are prevented from being removed from the upper and lower bore holes 114 and 116 and bore hole 128 of first and second lock bodies 102 and 120, thereby securing the first and second lock bodies 102 and 120 to one another and preventing opening of left and right doors 180 and 182 by unauthorized personnel. The user of the present invention may then simply remove the locking securement pin 140 from the first and second lock bodies 102 and 120 by releasing the locking mechanism 150 thus withdrawing locking pin 156 into lock body 152 and lifting the locking securement pin 140 and pin securement block 142 out of the upper and lower bore holes 114 and 116 of upper and lower lock engagement fingers 110 and 112 and bore hole 128 of projecting central finger 126, thus releasing the first and second lock bodies 102 and 120 from one another and permitting the left and right doors 180 and 182 to be opened.

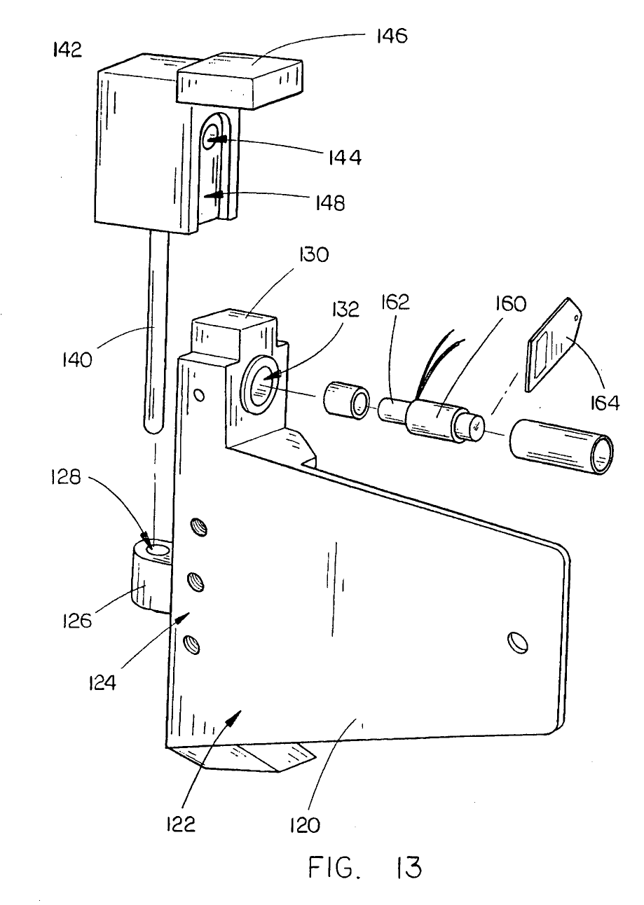

An alternative embodiment of the present invention is shown in FIG. 13 wherein the locking mechanism 150 is replaced by an electronic locking mechanism 160 which would be mounted within the locking mechanism mounting section 130 of second lock body 120 as was described previously. The benefit of the electronic locking mechanism 160 is that although it would function in generally the same manner as was described in connection with the Pagoda lock locking mechanism 150, i.e. the electronic locking mechanism 160 would also include a locking pin 162 which extends into the pin-receiving hole 144 of pin securement block 142 in substantially the same manner as described in connection with Pagoda lock locking mechanism 150, the electronic locking mechanism 160 may be operated merely by passing an identification card 164 in front of the electronic locking mechanism 160 or by remotely operating the electronic locking mechanism 160 to engage or disengage the locking pin 162 from the pin-receiving hole 144. Of course, many different types of locking mechanisms may be used in connection with the present invention so long as the general functionality of the locking mechanism is maintained to secure a locking pin within the pin-receiving hole 144. Finally, it should be noted that the pin securement lock 142 may also include a guide channel 148 formed on the inner face thereof adjacent the pin-receiving hole 144 to provide better alignment for the pin securement block 142 when it is placed on the first and second lock bodies 102 and 120. Inclusion of such a guide channel 148 will be understood by those skilled in the art of aligning functional parts of mechanical devices.

It is to be understood that numerous additions, modifications and substitutions may be made to the securement system 100 of the present invention which fall within the intended broad scope of the appended claims. For example, the size, shape and construction materials used in connection with the first and second lock bodies 102 and 120 may be modified or changed so long as the intended functional features of the elements are neither degraded nor destroyed. Furthermore, the precise arrangement of elements is only critical to the present invention in that the securement system 100 function as designed to secure the left and right doors 180 and 182 in a closed position when the securement system 100 is engaged, and therefore it may be reasonable to modify the arrangement of elements such as adding additional lock engagement fingers to increase the securement properties of the securement system 100 or modifying the orientation of the functional elements of the invention. Finally, it should be noted that although the present invention has been described as being designed for use in connection with tractor-trailer doors, it is adaptable for use with virtually any type of vehicle having rear opening doors and the use of the securement system 100 with such doors and the modifications inherent therein to permit such use will be understood by one skilled in the art.

There has therefore been shown and described a securement system 100 for vehicle doors which accomplishes at least all of its intended objectives.

I claim:

1. An improved securement system for the doors of vehicles, trailers or containers having two vertical side-by-side doors, said securement system comprising:
a first lock body including a mounting section and a first lock engagement section having a first bore hole extending through said first lock engagement section;
a second lock body including a mounting section, a second lock engagement section having a second bore hole extending through said second lock engagement section and a locking mechanism mounting section extending upwards therefrom;
said first lock body adapted to be mounted on a first door of the two vertical side-by-side doors via said mounting section;
said second lock body adapted to be mounted on a second door of the two vertical side-by-side doors via said mounting section;
said first and second lock bodies being aligned such that upon the first and second doors being closed, said first and second lock engagement sections engage one another with said first and second bore holes being generally concentrically aligned;
a locking mechanism mounted on said locking mechanism mounting section of said second lock body; and
locking means including a locking pin and an upper pin securement block mounted on said locking pin such that said locking pin extends at least partially through the aligned first and second bore holes and said pin securement block is aligned with said locking mechanism mounted on said second lock body such that said locking mechanism engages said pin securement block to releasably secure the locking pin in said aligned first and second bore holes thereby securing said first lock body to said second lock body and securing the first and second doors in closed position.

2. The securement system of claim 1 wherein said first and second lock bodies are constructed of a hardened steel material.

3. The securement system of claim 1 further comprising first and second backing plates and securement bolts, said securement bolts adapted to extend through said first and second backing plates, through the first and second doors and into said first and second lock bodies whereby said first and second lock bodies are secured on the first and second doors.

4. The securement system of claim 1 wherein said first and second lock bodies are secured on the first and second doors by securement means.

5. The securement system of claim 4 wherein no portion of said securement means are exposed outside of said first and second lock bodies when said securement means are operative to secure said first and second lock bodies on the first and second doors.

6. The securement system of claim 1 wherein said locking mechanism comprises a pagoda lock seated within said second lock body which includes a lock portion and a movable pin section, said pagoda lock operative to extend said pin section into said upper pin securement block of said locking means thereby releasably securing said first lock body to said second lock body and securing the first and second doors in closed position.

7. An improved securement system for the doors of vehicles, trailers or containers, said securement system comprising:
a first lock body including a mounting section and a first lock engagement section having at least one projecting finger having a bore hole extending therethrough;
a second lock body including a mounting section, a second lock engagement section having at least one projecting finger having a second bore hole extending through said at least one projecting finger and a locking mechanism mounting section mounted on said second lock body;
said first lock body adapted to be mounted on one door via said mounting section;
said second lock body adapted to be mounted on another adjacent door via said mounting section;
said first and second lock bodies being aligned on the doors such that upon the doors being closed, said at least one projecting fingers of said first and second lock engagement sections of said first and second lock bodies are aligned with said bore holes therein being generally concentrically aligned;
a locking mechanism mounted on said locking mechanism mounting section of said second lock body; and
locking means including a locking pin and an upper pin securement block mounted on said locking pin such that said locking pin extends at least partially through said aligned bore holes in said at least one projecting fingers of said first and second lock engagement sections of said first and second lock bodies and said pin securement block is aligned with said locking mechanism mounted on said second lock body such that said locking mechanism engages said pin securement block to releasably secure said locking pin in said aligned bore holes thereby securing said first lock body to said second lock body and securing the doors in closed position.

8. The securement system of claim 7 wherein said first and second lock bodies are constructed of a hardened steel material.

9. The securement system of claim 7 further comprising first and second backing plates and securement bolts, said securement bolts adapted to extend through said first and second backing plates, through the doors and be secured within said first and second lock bodies whereby said first and second lock bodies are secured on the doors.

10. The securement system of claim 7 wherein said first and second lock bodies are secured on the doors by securement means.

11. The securement system of claim 10 wherein no portion of said securement means are exposed outside of said first and second lock bodies when said securement means are operative to secure said first and second lock bodies on the doors.

12. The securement system of claim 7 wherein said locking mechanism comprises a pagoda lock seated within said second lock body which includes a lock portion and a movable pin section, said pagoda lock operative to extend said pin section into said upper pin securement block of said locking means thereby releasably securing said first lock body to said second lock body and securing the first and second doors in closed position.
